(19) United States
(12) Patent Application Publication
(10) Pub. No.: US 2011/0161030 A1
(43) Pub. Date: Jun. 30, 2011

(54) Method And Device For Monitoring Measurement Data In Semiconductor Process

(75) Inventors: Haijun Niu, Shanghai (CN); Lixia Yang, Shanghai (CN); Qi Sun, Shanghai (CN)

(73) Assignee: Semiconductor Manufacturing International (Shanghai) Corporation, Shanghai (CN)

(21) Appl. No.: 12/976,872

(22) Filed: Dec. 22, 2010

(30) Foreign Application Priority Data
Dec. 31, 2009 (CN) 200910248082.0

(51) Int. Cl. G06F 17/18; G06F 19/00

(52) U.S. Cl. 702/81; 702/179

(57) ABSTRACT

An embodiment of the present invention discloses a method for monitoring measurement data in a semiconductor process, which includes: updating measurement data of wafer performance parameters periodically from a real time system into an analysis database; retrieving from the analysis database the measurement data of a predetermined performance parameter for analysis covered in a time range required in a selected analysis rule according to information on the performance parameter for analysis and information on the selected analysis rule; determining whether the measurement data of the performance parameter retrieved from the analysis database violates a control range of the selected analysis rule, and if so, then transmitting alarm information for the performance parameter violating the control range of the selected analysis rule. The method and device according to the embodiments of the invention can automatically monitor measurement data of wafer performance parameters and discover an abnormal performance parameter.

### FIELD OF THE INVENTION

The present invention relates to the field of semiconductor manufacturing, and in particular to a method and a device for monitoring measurement data in a semiconductor process.

### BACKGROUND OF THE INVENTION

Measurement data in a semiconductor process relates to a direct parameter reflecting the result of a preceding process, e.g., the thickness and uniformity of a film, the depth of a trench, etc. A failing machine stage of a preceding wafer process may cause a lowered yield of wafers and consequential abnormal fluctuation of the measurement data. The measurement data shall be monitored effectively to ensure stability of the process and reduce abnormality arising on a production line.

A traditional online monitoring system provides a user with a function of monitoring a single point or consecutive points, and the sc-called point refers to a point of measurement data. The online monitoring system can allow the user to select only one parameter for monitoring without any automatic analysis function. Moreover, the online monitoring system does not allow retrieval of excessive data e.g., monthly measurement data, at a time, but instead allows retrieval of weekly measurement data at a time. The maximum amount of data allowed to be retrieved at a time is determined by the performance of the online monitoring system. Stated otherwise, since retrieval of data from the online monitoring system may influence the operative performance of the online monitoring system itself, the amount of data retrieved at a time which will just cause the online monitoring system to be inoperative is the maximum amount of data allowed by the online monitoring system to be retrieved at a time. If a long term trend analysis is required on the measurement data, then respective parts of the required data have to be retrieved manually in a sequence of batches, and the measurement data can not be monitored automatically due to low efficiency. Moreover, it is typical for an engineer to view problematic measurement data only if a problem arises during existing monitoring of the measurement data, but a loss will have been incurred when the measurement data is viewed. Summarily, the existing online monitoring system fails to monitor automatically the measurement data and consequently suffer from low efficiency and also fails to discover in advance abnormal measurement data.

U.S. Pat. No. 7,099,729 discloses a semiconductor process and yield analysis integrated real-time management method, which includes inspecting a plurality of semiconductor products with a plurality of items during a semiconductor process, and recording a plurality of inspecting results of each semiconductor product; classifying the semiconductor products as a plurality of groups with a predetermined rule, generating raw data according to the inspecting results of each group, and recording the raw data and the corresponding groups in a database; indexing a plurality of semiconductor product groups from the database by a predetermined product rule, indexing the corresponding raw data of each semiconductor product group by a predetermined parameter, and calculating a corresponding analysis result from the indexed semiconductor product groups and raw data with an analysis module; and displaying the analysis result according to the indexed semiconductor product groups and the raw data. The technical solution in this patent suggests only how to store the indexed inspecting results in the database to enable a flexible data query for analysis but fails to suggest a method for discovering abnormal measurement data in advance.

### SUMMARY OF THE INVENTION

In view of this, an object of the invention is to provide a method and device for monitoring measurement data in a semiconductor process, which can automatically monitor measurement data of wafer performance parameters and discover an abnormal performance parameter.

In order to attain the foregoing object, an embodiment of the invention provides a method for monitoring measurement data in a semiconductor process, which includes:

updating measurement data of wafer performance parameters periodically from a real time system into an analysis database;

retrieving from the analysis database the measurement data of a predetermined performance parameter for analysis covered in a time range required in a selected analysis rule according to information on the performance parameter for analysis and information on the selected analysis rule;

determining whether the measurement data of the performance parameter retrieved from the analysis database violates a control range of the selected analysis rule, and if so, then transmitting alarm information for the performance parameter violating the control range of the selected analysis rule.

In another aspect, an embodiment of the invention provides a device for monitoring measurement data in a semiconductor process, which includes:

an updating unit adapted to update measurement data of wafer performance parameters periodically from a real time system into an analysis database;

a retrieval unit adapted to retrieve from the analysis database the measurement data of a predetermined performance parameter for analysis covered in a time range required in a selected analysis rule according to information on the performance parameter for analysis and information on the selected analysis rule;

a determination unit adapted to determine whether the measurement data of the performance parameter retrieved from the analysis database violates a control range of the selected analysis rule; and

an alarm information transmission unit adapted to transmit alarm information for the performance parameter violating the control range of the analysis rule when a determination result of the determination unit is positive.

The method and device according to the embodiments of the invention can automatically monitor measurement data of a wafer performance parameter, determine whether the measurement data of the performance parameter violates the control range of a selected analysis rule and discover abnormality of the performance parameter upon determination that the control range is isolated. As compared with the prior art in which an engineer has to view problematic data only if a problem actually occurs with a wafer, the embodiments of the invention monitor automatically measurement data of a performance parameter using a preset rule to thereby discover in advance abnormal data of the performance parameter.

### BRIEF DESCRIPTION OF THE DRAWINGS

The drawings used to describe the embodiments of the invention or the prior art will be described briefly below to make the technical solutions in the embodiments or in the prior art more apparent, and evidently the drawings below are merely illustrative of some of the embodiments of the invention and those ordinarily skilled in the art can derive from these drawings other drawings without any inventive effort.

FIG. 1 is a flow chart of a method for monitoring measurement data in a semiconductor process according to an embodiment of the invention;

FIG. 2 is a schematic diagram of discovering an abnormal data point by a server which monitors measurement data of a wafer performance parameter using an analysis rule according to a first embodiment of the invention;

FIG. 3 is a schematic diagram of discovering an abnormal data point by a server which monitors measurement data of a wafer performance parameter using an analysis rule according to a third embodiment of the invention;

FIG. 4 is a schematic diagram of discovering an abnormal data point by a server which monitors measurement data of a wafer performance parameter using an analysis rule according to a fourth embodiment of the invention;

FIG. 5 is a schematic diagram of discovering an abnormal data point by a server which monitors measurement data of a wafer performance parameter using an analysis rule according to a sixth embodiment of the invention;

FIG. 6 is a flow chart of a device for monitoring measurement data in a semiconductor process according to an embodiment of the invention;

FIG. 7 is a schematic diagram of an embodiment of a determination unit in FIG. 6; and

FIG. 8 is a schematic diagram of another embodiment of a determination unit in FIG. 6.

### DETAILED DESCRIPTION OF THE INVENTION

The technical solutions according to the embodiments of the invention will be described clearly and fully below with reference to the drawings in the embodiments of the invention to make the objects, aspects and advantages thereof more apparent. Evidently the described embodiments are a part but not all of the embodiments of the invention. Based upon the embodiments of the invention, any other embodiments which will occur to those ordinarily skilled in the art without any inventive effort shall come within the claimed scope of the invention.

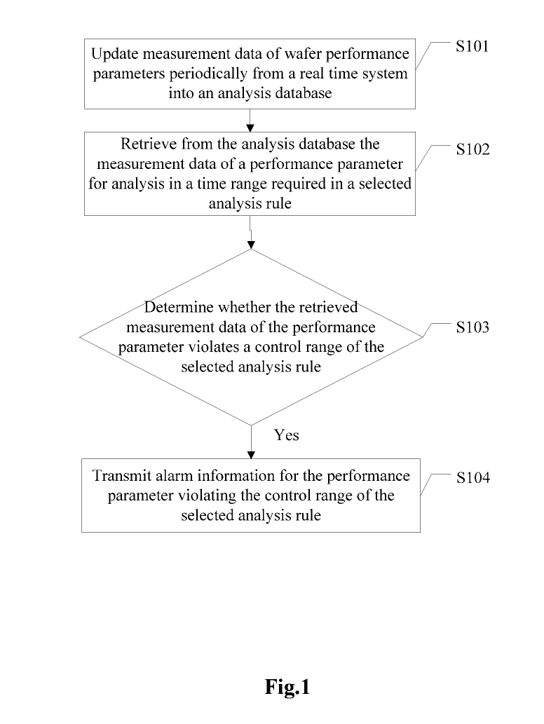

An embodiment of the invention provides a method for monitoring measurement data in a semiconductor process as illustrated in FIG. 1, which includes:

Step S101: measurement data of wafer performance parameters is updated periodically from a real time system into an analysis database;

The real time system in an embodiment of the invention is adapted to collect measurement data of wafer performance parameters from respective machine stages but may not provide an online monitoring function.

Since measurement data for analysis is stored in the analysis database in an embodiment of the invention, the analysis database can facilitate analysis and monitoring of the measurement data (for example, trend and statistic analysis of the measurement data of a performance parameter over a longer period of time) for the real time system during analysis and monitoring of the data. The analysis database is an offline database which can be built in a common offline database building method.

Step S102: the measurement data of a predetermined performance parameter for analysis covered in a time range required in a selected analysis rule is retrieved from the analysis database according to information on the performance parameter for analysis and information on the selected analysis rule. The time range can vary with the varying analysis rule, e.g., the data in the last week, month, etc.

Step S103: It is determined whether the measurement data of the performance parameter retrieved in the step S102 from the analysis database violates a control range of the selected analysis rule, and if so, then the procedure goes to the step S104.

Here, the control range of the analysis rule can be predetermined as input by an engineer or calculated in real time from the measurement data of the performance parameter.

In an embodiment of the invention, a rule or set of rules can be selected which varies with the varying performance parameter, and the number of measurement data points for analysis (or referred to as sample points), i.e., the time range in which the measurement data is covered, can also vary with the varying rule.

Step S104: Alarm information is transmitted for the performance parameter violating the control range of the selected analysis rule.

An execution body of the foregoing respective steps can be located in a server or a user terminal, and in the former case, the alarm information transmitted in the step S104 can be destined for the user terminal.

The performance parameter violating the control range of the rule is typically an abnormal performance parameter, and upon reception of the alarm information for a performance parameter, the user terminal can invoke a profile of the measurement data of the performance parameter in a problematic period of time and further analysis a problem of the measurement data of the abnormal performance parameter.

Moreover in the case that measurement data of a performance parameter is monitored with a traditional online monitoring system, the measured parameter can be monitored only as a whole, but a machine stage where a wafer is located when the measurement data is generated can not be identified. In order to enable a user to determined more intuitively which machine stage causes abnormality of the performance parameter, it is preferred in an embodiment of the invention that machine stage identifier data corresponding to the measurement data of a wafer performance parameter is stored in the real time system, and in an embodiment of the invention the batch of a wafer from which the measurement data of the wafer performance parameter is acquired will not be identified but the machine stage of that wafer can be identified, so information on the source of the measurement data (i.e., the identifier of the machine stage) can be recorded along with reception at the real time system of the measurement data of the wafer performance parameters and thus the respective pieces of measurement data will be provided with a corresponding identifier of machine stage. When the measurement data of the wafer performance parameters is updated into the analysis database, the machine stage identifier data corresponding to the respective pieces of measurement data will also be updated into the analysis database. Thus, the server can group the respective pieces of measurement data of the wafer performance parameters by machine stage identifiers and display the grouped measurement data in a plot in a sequence of times when the measurement data is acquired, and the displayed part of the measurement data can include only the measurement data acquired in the latest period of time. Upon reception of the alarm information for a wafer performance parameter, the user terminal can transmit an instruction to the server so that the server will group the measurement data of the abnormal performance data in the latest period of time by machine stage identifiers and arrange the measurement data in each group in a sequence of times when the measurement data is acquired. Thus, a user can identify intuitively the machine stage of a wafer with the abnormal measurement data, so that an engineer can adjust directly a machine stage parameter of the machine stage accordingly to correct an influence of the machine stage upon the wafer performance parameter. Summarily, the server performs the following steps: measurement data of wafer performance parameters and the identifiers of machine stages where a wafer is located when the measurement data is generated are updated into an analysis database; the server retrieves from the analysis database the measurement data of a predetermined performance parameter for analysis covered in a time range required in a selected analysis rule according to information on the performance parameter for analysis and information on the selected analysis rule; then the server determines whether the measurement data of the performance parameter retrieved from the analysis database violates a control range of the selected analysis rule, and if so, then the server transmits alarm information to a user terminal. If the server receives a request transmitted from the user terminal to view the performance parameter associated with the alarm, then the server groups the measurement data of the abnormal performance data in the latest period of time by machine stage identifiers, arranges the measurement data in each group in a sequence of times when the measurement data is acquired, generates a plot from an arrangement result and transmits it to the user terminal.

Specific implementation of the embodiments of the invention will be detailed below in several specific examples.

### The First Embodiment

The control range of an analysis rule is predetermined in the present embodiment.

In the present embodiment, it is determined whether measurement data is abnormal using a rule that the value of a single data point or the values of plural data points exceed the predetermined control range.

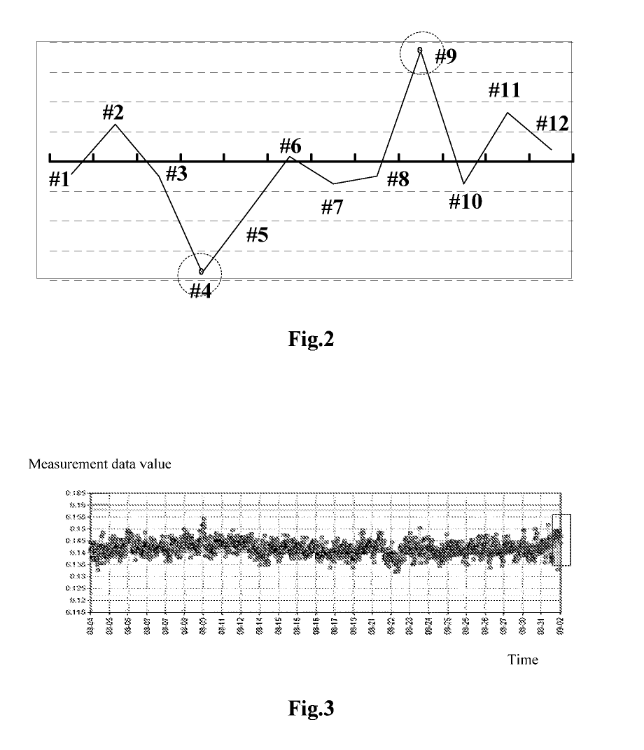

Taking as example the selected analysis rule that a single measurement data point exceeds the predetermined control range, FIG. 2 illustrates a schematic diagram of discovering an abnormal data point by the server which monitors measurement data of a wafer performance parameter using the selected analysis rule. FIG. 2 particularly illustrates an example in which the control range is three times a standard deviation, and the server determines that the control range of the analysis rule is violated upon determining that the values of a measurement data point of the wafer performance parameter exceed the control range and transmits an alarm for the wafer performance parameter. For example, an alarm is transmitted for the wafer performance parameter because the measurement data point numbered #9 violates the control range of the analysis ml. Moreover, a rule can also be set that the control range corresponding to the analysis rule is violated when the number of measurement data points each of which exceeds the predetermined control range exceeds a predetermine number. For example, it can be determined that the control range corresponding to the analysis rule is violated when the number of measurement data points each with a value exceeding three times a standard deviation exceeds three.

It shall be noted that the rule selected in the present embodiment will not be limited to those listed above, and the claimed scope of the embodiments of the invention will encompass any rule in which no trend analysis of measurement data points (e.g., continuous descending or ascending) is involved and by which one or more measurement data points are compared with a preset value and it is determined from a comparison result or a statistic result thereof whether the rule is violated.

### The Second Embodiment

The control range of an analysis rule is calculated in real time in the present embodiment.

In the present embodiment, it is determined whether a measurement data point is abnormal using a specific rule that measurement data points of a wafer performance parameter are arranged in a sequence of times when they are acquired, a control range is calculated from the measurement data in the earliest period of time, the values of the measurement data arranged in the middle among the measurement data in the latest period of time following the earliest period of time are compared with the foregoing calculated control range, and if the control range is violated, then it is determined that the rule is violated and an alarm is transmitted.

Particularly, the length of the earliest period of time is twice that of the latest period of time. For example, if T represents the time range of the retrieved measurement data of the wafer performance parameter, then the earliest period of time can be the first 2T/3 period of time and the latest period of time can be the last T/3 period of time.

Particularly, the control range can be calculated from the measurement data in the earliest period of time particularly using the following method:

The control range has an upper limit of Q2−3*(Q2−Q1)/(1.34898/2) and a lower limit of Q2+3*(Q3−Q2)/(1.34898/2), where Q1 represents a measurement data point arranged at the ¼ range in a sequence of acquisition times, Q2 represents a measurement data point arranged at the ½ range in a sequence of acquisition times, and Q3 represents a measurement data point arranged at the ¾ range in a sequence of acquisition times.

In the method according to the first embodiment, an alarm will be transmitted only if the values exceed the predetermined control range which is present, and this is particularly suitable for short term monitoring; and in the method according to the present embodiment, the data is segmented and then the succeeding set of data is compared with the preceding set of data, and the control range is calculated from the preceding set of data, so the method according to the present embodiment takes into account a condition that the data violates the control range but also reflects a condition across the sets of data.

### The Third Embodiment

The control range of an analysis rule is predetermined in the present embodiment.

A rule adopted in the present embodiment relates to a process capability index of measurement data. The process capability index (CPK) can also reflect denseness of a profile of the measurement data of a performance parameter and closeness of the average of the measurement data to a target value.

The process capability index can be calculated with (1−k)Cp, where Cp represents a process capability index, and k represents process preciseness, so Cp can reflect denseness of a profile of the measurement data, and 1−k can reflects closeness of the average of the performance parameter to the target value.

Cp can be calculated with the following equation:

$$Cp = \frac{USL - LSL}{6 σ} \qquad ( Equation 1 )$$

Where USL represents an upper limit of specification, LSL represents a lower limit of specification, and σ represents a standard deviation calculated from a set of measurement data from which the process capability index is calculated and reflects discreteness of the measurement data.

k can be calculated with the following equation:

$$K = \frac{\vert Target - Average \vert}{\frac{1}{2} ( USL - LSL )} \qquad ( Equation 2 )$$

Where USL represents an upper limit of specification, LSL represents a lower limit of specification, Target represents a user preset target value, and Average represents the average of a set of measurement data from which the process capability index is calculated.

The upper limit of specification and the lower limit of specification each refer to such a limit that a produce exceeding the limit will be rejected. The upper limit of specification and the lower limit of specification are generally derived experimentally or user preset.

Upon acquisition of the process capability index of the measurement data of the performance parameter in a predetermined period of time, the server compares the process capability index with a first threshold and determines that the rule is violated if the process capability index is below the first threshold and descends with a trend of an extent exceeding a predetermined extent.

The foregoing extent of a trend with which the process capability index descends can be as follows: the measurement data of the performance parameter is arranged in a sequence of times, the process capability indexes of the measurement data in the earliest period of time and in the latest period of time following the earliest period of time are calculated, the process capability index in the earliest period of time is subtracted from that in the latest period of time, the resultant difference is divided by the process capability index in the earliest period of time, and the resultant quotient is determined as the value of the extent of a trend with which the process capability index descends. Particularly, the length of the earliest period of time is preferably longer than that of the latest period of time. For example, the last week is selected as the earliest period of time, and the first day following that week is selected as the latest period of time. The earliest period of time with a longer length can ensure more accurate calculation of the process capability of index, and the latest period of time with a shorter length can accommodate monitoring.

FIG. 3 illustrates a schematic diagram of discovering abnormal data by the server which monitors measurement data of a wafer performance parameter using the analysis rule selected in the present embodiment. As illustrated in FIG. 3, it is apparent from calculation that the measurement data of the performance parameter violates the control range of the foregoing rule in the succeeding period of time in the Figure (i.e., the range circled with a bold rectangular block in the Figure), so the server determines abnormality of the performance parameter and transmits alarm information to the user terminal.

### The Fourth Embodiment

The control range of an analysis rule is predetermined in the present embodiment.

A positive or negative deviation of measurement data of a performance parameter can be discovered using the rule in the third embodiment, but a result of determination using the rule in the third embodiment may not be accurate in the case that the values of measurement data are subject to diverging oscillation.

In view of the foregoing, the present embodiment proposes a determination rule particularly as follows:

Curve fitting can be performed for measurement data of a performance parameter in a predetermined period of time using a cubic spline interpolation algorithm in which a differential point is determined as an origin point, i.e., a set of values derived with a Locally Weighted Scatterplot Smoothing (LOWESS) algorithm. The essence of the LOWESS lies in that local data in a specific proportion is selected and a polynomial regression curve is fitted in this part of subset, so we can observe the regularity and trend that the data exhibits locally. Typical regression analysis tends to create a model for an ensemble of data to describe a trend as a whole, but regularity in the real world will not always (or seldom) appear like a line as taught in a textbook. The local range is extended sequentially from the left to the right to finally derive a continuous curve.

Corresponding values derived from curve fitting are subtracted from the respective values of the measurement data, linear regression is performed for the resultant differences to derive the value of p of linear regression, and the values of p and R_qruared are derived to determine that the measurement data violates the rule.

Where, the value of p is a probability value resulting from linear regression, i.e., a probability value resulting from F distribution like the value of the origin point, and reflects dissimilarity of the value resulting from linear regression to the original value and thus superiority or inferiority of a linear model.

R_qruared referred to as a relevance coefficient of the equation ranges from 0 to 1, and R_qruared closer to one indicates a higher capability of a variable of the equation to explain y. R_qruared can be taken as a criterion of different models. If no model of data can be determined prior to fitting of the data, then different mathematical forms of a variable can be fitted, and then larger R_qruared of a model indicates better data fitting of this model. The value of p corresponding to the linear regression model with the largest R_qruared is selected as a criterion for determining whether the rule is violated.

When the value of p is below a preset threshold, then it can be determined that the data violates the rule. In the present embodiment, the value of p can reflect superiority or inferiority of a linear model, and also it can be determined the data violates the rule when the value of p is below the preset threshold, which indicates a positive or negative differential variation over time.

A measurement data point subject to diverging oscillation can be discovered using the determination method in the present embodiment to thereby transmit an alarm.

Moreover, measurement data points to be processed are preferably denoised to filter out data points adverse to correctness of a fitting result (referred to as noisy points) prior to curve fitting and linear regression in order to prevent the noisy points from being involved in a statistic process.

The noisy points can be filtered out in a variety of methods, preferably by a distance of cook in the present embodiment. Specifically, such a method is that a regression equation is observed and a distance of cook between a predicated value in the regression equation after the i^{th} observation and an actual value is removed to thereby determine whether the i^{th} observation value relates to a largely influencing point. This integrates an influence capability of a sample upon a model and an extent of deviation from normality. The statistic of cook is used to determine a critical value of an abnormal point of value (referred to as a second threshold), which is typically set as 1/n. and the inventors have experimentally identified this critical value as 1.0.

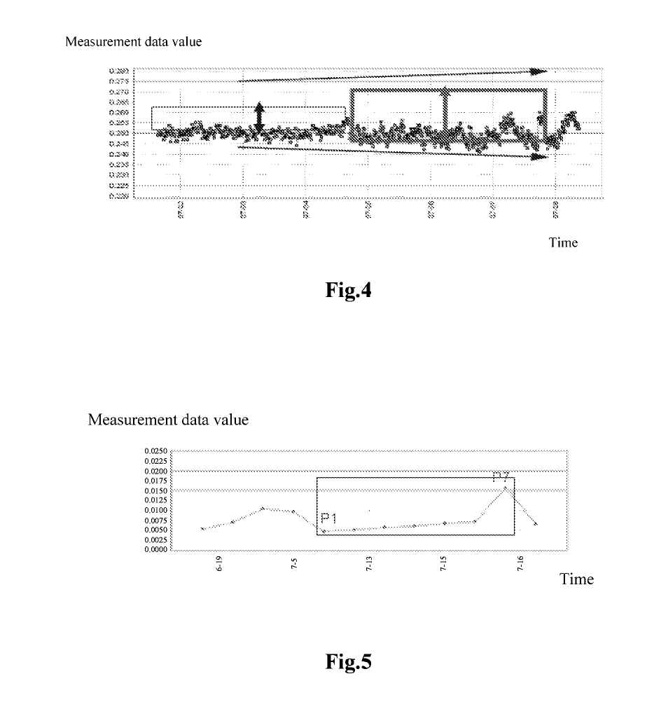

FIG. 4 illustrates a schematic diagram of discovering abnormal data by the server which monitors measurement data of a wafer performance parameter using the analysis rule selected in the present embodiment. As illustrated in FIG. 4, measurement data points in the succeeding period of time in the Figure are subject to diverging oscillation and abnormality of the measurement data can be discovered using the rule based determination method in the present embodiment to thereby transmit alarm information to the user terminal.

### The Fifth Embodiment

The control range of an analysis rule is calculated in real time in the present embodiment. Moreover, the analysis rule in the present embodiment is a combination of two rules referred hereinafter to as a first rule and a second rule.

It can be determined whether the control range of the rule is violated according to the present embodiment particularly as follows: the server checks the linear fitting extent of the values of p resulting from linear regression performed on measurement data of a performance parameter in a predetermined period of time, selects a linear regression model with the largest value of p, determines from a fitting result of the selected linear regression model (e.g., the slope of a line resulting from fitting) a positive or negative trend of measurement data points, and except the case of a trend of approaching a target value, it is determined that the first rule is violated upon discovering a positive or negative trend of the varying measurement data deviating from the target value, and it is determined whether the rule in the second embodiment is also violated, i.e., whether the second rule is also violated, and if both the first and second rules are violated, then it is determined that the measurement data violates the control range of the analysis rule in the present fifth embodiment and an alarm is transmitted.

### The Sixth Embodiment

The control range of an analysis rule is predetermined in the present embodiment.

A rule adopted in the present embodiment relates to an ascending or descending trend of measurement data points. Specifically, such a rule can be adopted that it is determined that the rule is violated when a predetermined number of consecutive values of measurement data of a performance parameter ascend or descend gradually.

The inventors have identified experimentally that the foregoing predetermined number of consecutive values is preferably 7. As illustrated in FIG. 5, seven data points, i.e., measurement data points P1 to P7, ascend continuously, so the rule is violated, and the server will generate an alarm for a corresponding performance parameter.

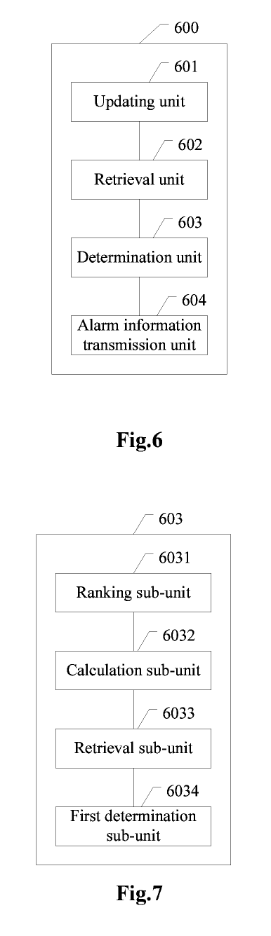

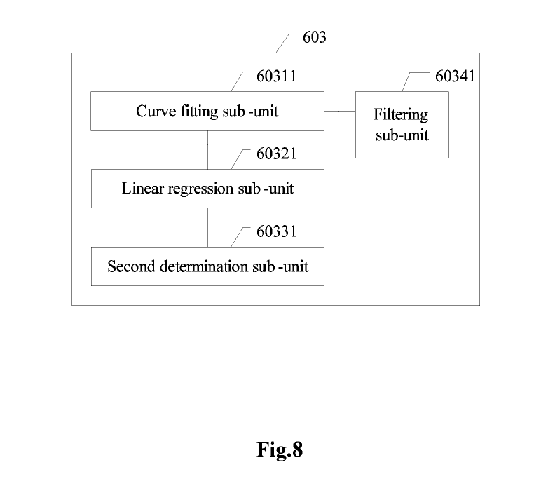

On the other hand, an embodiment of the invention further provides a device for monitoring measurement data in a semiconductor process, and as illustrated in FIG. 6, the device 600 includes:

An updating unit 601 adapted to update measurement data of wafer performance parameters periodically from a real time system into an analysis database;

A retrieval unit 602 adapted to retrieve from the analysis database the measurement data of a predetermined performance parameter for analysis covered in a time range required in a selected analysis rule according to information on the performance parameter for analysis and information on the selected analysis rule;

A determination unit 603 is adapted to determine whether the measurement data of the performance parameter retrieved from the analysis database violates a control range of the selected analysis rule; and

An alarm information transmission unit 604 adapted to transmit alarm information for the performance parameter violating the control range of the analysis rule when a determination result of the determination unit 603 is positive.

Particularly, the foregoing respective units can operate as in the respective steps in the foregoing first to sixth embodiments, and repeated descriptions thereof will be omitted here.

Particularly, when the determination unit 603 operates using the analysis rule selected in the second embodiment, the determination unit 603 as illustrated can include:

A ranking sub-unit 6031 adapted to rank retrieved measurement data points of the wafer performance parameter in a sequence of times they are acquired;

A calculation sub-unit 6032 adapted to calculate a control range from the measurement data of the performance parameter in the earliest period of time;

A retrieval sub-unit 6033 adapted to retrieve the values of the measurement data arranged in the middle of the latest period of time; and

A first determination sub-unit 6034 adapted to determine whether the values of the measurement data arranged in the middle of the latest period of time exceed the control range calculated by the calculation sub-unit 6032, and to determine that the control range of the analysis rule is violated if the control range is exceeded.

When the determination unit 603 operates using the analysis rule selected in the fourth embodiment, the determination unit 603 as illustrated in FIG. 9 includes:

A curve fitting sub-unit 60311 adapted to perform curve fitting on the measurement data of the performance parameter in a predetermined period of time;

A linear regression sub-unit 60321 adapted to perform linear regression on the differences resulting from subtracting corresponding values resulting from curve fitting from the values of the measurement data; and

A second determination sub-unit 60331 adapted to determine whether the fitting degree of linear fitting is below a predetermined threshold, and to determine that the control range of the analysis rule is violated when a determination result is positive.

A filtering sub-unit 60341 can further be included which is adapted to remove a measurement data point with a distance of cook exceeding a second threshold before the curve fitting sub-unit 60311 performs curve fitting on the measurement data of the performance parameter in the predetermined period of time.

The device for monitoring measurement data in a semiconductor process according to the invention can automatically monitor measurement data of wafer performance parameters and discover an abnormal parameter.

The foregoing descriptions are merely illustrative of the preferred embodiments of the invention, and it shall be noted that those ordinarily skilled in the art can further make several adaptations and variations without departing from the spirit of the invention and these adaptations and variations shall also be construed as coming within the scope of the invention.

1. A method for monitoring measurement data in a semiconductor process, comprising:
updating measurement data of wafer performance parameters periodically from a real time system into an analysis database;
retrieving from the analysis database the measurement data of a predetermined performance parameter for analysis covered in a time range required in a selected analysis rule according to information on the performance parameter for analysis and information on the selected analysis rule;
determining whether the measurement data of the performance parameter retrieved from the analysis database violates a control range of the selected analysis rule, and if so, transmitting alarm information for the performance parameter violating the control range of the selected analysis rule.

2. The method according to claim 1, wherein the control range of the analysis rule is predetermined.

3. The method according to claim 2, wherein determining whether the control range of the analysis rule is violated comprises:
determining that the control range of the analysis rule is violated when the number of measurement data points among the values of the measurement data exceeding the predetermined control range exceeds a predetermined number.

4. The method according to claim 2, wherein determining whether the rule is violated comprises: performing curve fitting on the retrieved measurement data of the performance parameter; performing; linear regression on the differences resulting from subtracting corresponding values resulting from curve fitting from the values of the measurement data; and determining that the control range of the analysis rule is violated upon determining that the fitting degree of linear fitting is below a predetermined threshold.

5. The method according to claim 4, further comprising: removing a measurement data point with a distance of cook exceeding a second threshold prior to curve fitting on the retrieved measurement data of the performance parameter.

6. The method according to claim 5, wherein the distance of cook of a piece of measurement data of the performance parameter is the distance between a fitting equation with the piece of measurement data removed and an actual value of the piece of measurement data.

7. The method according to claim 2, wherein determining whether the control range of the analysis rule is violated comprises: determining whether a predetermined number of consecutive measurement data points ascend gradually; and if so, determining that the control range of the analysis rule is violated.

8. The method according to claim 2, wherein determining whether the control range of the analysis rule is violated comprises: determining whether a predetermined number of consecutive measurement data points descend gradually; and if so, determining that the control range of the analysis rule is violated.

9. The method according to claim 2, wherein determining whether the control range of the analysis rule is violated comprises: calculating a process capability index from the retrieved measurement data of the performance parameter, and determining that the control range of the analysis rule is violated when the calculated process capability index is below a first threshold and descends with a trend of an extent exceeding a predetermined extent, wherein the extent of a trend with which the process capability index of the measurement data of the performance parameter descends is as follows: subtracting the process capability index of the measurement data of the performance parameter in the earliest period of time in the predetermined period of time from that in the latest period of time in the predetermined period of time, dividing the resultant difference by the process capability index of the measurement data of the performance parameter in the earliest period of time, and determining the resultant quotient as the extent of a trend with which the process capability index descends, wherein the length of the latest period of time is shorter than that of the earliest period of time.

10. The method according to claim 1, wherein the control range of the analysis rule is calculated in real time from the measurement data of the wafer performance parameter.

11. The method according to claim 10, wherein determining whether the control range of the analysis rule is violated comprises: arranging retrieved measurement data points of the wafer performance parameter in a sequence of times when they are acquired, calculating the control range from the measurement data of the performance parameter in the earliest period of time, retrieving the measurement data of the performance parameter in the latest period of time, comparing the values of the measurement data arranged in the middle of the latest period of time with the calculated control range, and if the control range is violated, determining that the control range of the analysis rule is violated.

12. The method according to claim 10, wherein determining whether the control range of the analysis rule is violated comprises: performing linear regression on the retrieved measurement data of the performance parameter, deriving from a linear regression result a trend with which the measurement data varies, and determining that a first rule is violated when the measurement data varies with a positive or negative trend deviating from a target value;
arranging retrieved measurement data points in a sequence of times when they are acquired, calculating the control range from the retrieved measurement data of the performance parameter in the earliest period of time, retrieving the measurement data of the performance parameter in the latest period of time, comparing the values of the measurement data arranged in the middle of the latest period of time with the calculated control range, and if the control range is violated, determining that a second rule is violated; and
determining whether the control range of the analysis rule is violated if both the first and second rules are violated.

13. The method according to claim 9, wherein the real time system further comprises machine stage identifier data corresponding to the measurement data of the wafer performance parameters, and updating the measurement data of the wafer performance parameters into the analysis database comprises: updating the measurement data of the wafer performance parameters and the corresponding machine stage identifier data into the analysis database.

14. The method according to claim 13, further comprising: grouping the measurement data of the wafer performance parameters by machine stage identifiers, and then displaying in a plot the measurement data in a sequence of times when the measurement data is acquired.

15. A device for monitoring measurement data in a semiconductor process, comprising:
an updating unit adapted to update measurement data of wafer performance parameters periodically from a real time system into an analysis database;
a retrieval unit adapted to retrieve from the analysis database the measurement data of a predetermined performance parameter for analysis covered in a time range required in a selected analysis rule according to information on the performance parameter for analysis and information on the selected analysis rule;
a determination unit adapted to determine whether the measurement data of the performance parameter retrieved from the analysis database violates a control range of the selected analysis rule; and
an alarm information transmission unit adapted to transmit alarm information for the performance parameter violating the control range of the analysis rule when a determination result of the determination unit is positive.

16. The device according to claim 15, wherein the determination unit comprises:
a ranking sub-unit adapted to rank retrieved measurement data points of the wafer performance parameter in a sequence of times they are acquired;
a calculation sub-unit adapted to calculate a control range from the measurement data of the performance parameter in the earliest period of time;
a retrieval sub-unit adapted to retrieve the values of the measurement data arranged in the middle of the latest period of time; and
a first determination sub-unit adapted to determine whether the values of the measurement data arranged in the middle of the latest period of time exceed the control range calculated by the calculation sub-unit, and to determine that the control range of the analysis rule is violated if the control range is exceeded.

17. The device according to claim 15, wherein the determination unit comprises:
a curve fitting sub-unit adapted to perform curve fitting on the measurement data of the performance parameter in a predetermined period of time;
a linear regression sub-unit adapted to perform linear regression on the differences resulting from subtracting corresponding values resulting from curve fitting from the values of the measurement data; and
a second determination sub-unit adapted to determine whether the fitting degree of linear fitting is below a predetermined threshold, and to determine that the control range of the analysis rule is violated when a determination result is positive.

18. The device according to claim 17, wherein the determination unit comprises:
a filtering sub-unit adapted to remove a measurement data point with a distance of cook exceeding a second threshold before the curve fitting sub-unit performs curve fitting on the measurement data of the performance parameter in the predetermined period of time.

19. The method according to claim 12, wherein the real time system further comprises machine stage identifier data corresponding to the measurement data of the wafer performance parameters, and updating the measurement data of the wafer performance parameters into the analysis database comprises: updating the measurement data of the wafer performance parameters and the corresponding machine stage identifier data into the analysis database.
